(19) United States
(12) Patent Application Publication
(10) Pub. No.: US 2017/0372049 A1
(43) Pub. Date: Dec. 28, 2017

(54) SYSTEMS AND METHODS FOR SEQUENTIAL BIOMETRIC MATCHING

(71) Applicant: Synaptics Incorporated, San Jose, CA (US)

(72) Inventor: Kinh Tieu, Sunnyvale, CA (US)

(21) Appl. No.: 15/193,923

(22) Filed: Jun. 27, 2016

(51) Int. Cl. G06F 21/32; G06F 21/36

(52) U.S. Cl. CPC G06F 21/32; G06F 21/36

(57) ABSTRACT

Systems and methods for sequential matching during user authentication are disclosed. A process for authenticating includes acquiring a first set of biometric data during a first authentication attempt and comparing the first set of biometric data with a set of enrollment data. The process further includes acquiring a second set of biometric data during a second authentication attempt, the second authentication attempt being subsequent to the first authentication attempt; comparing the second set of biometric data with the set of enrollment data; and forming a match score based analysis of the first set of biometric data, the second set of biometric data and the set of enrollment data. The process authenticates the user when sufficient confidence of a match exists.

### FIELD

This disclosure relates generally to the field of biometrics and, more specifically, to systems and methods for sequential biometric matching.

### BACKGROUND

Biometric sensing technology has greatly facilitated identification and authentication processes. Such processes typically include storing one or more sets of biometric data (e.g., fingerprint images, facial features or measurements, retinal images and the like) captured by a biometric sensor as an enrollment template for later authentication. During authentication, newly acquired verification biometric data is received and compared to enrolled template data to determine whether a match exists.

Challenges remain in biometric sensing and authentication. One problem relates to false rejections and high false rejection rate (“FRR”). A false rejection occurs when the system fails to recognize an authorized user. FRR is the probability that a given authentication attempt will result in a false rejection. A high FRR is, in turn, associated with poor user experience since it requires an authorized user to frequently engage in multiple authentication attempts.

Unfortunately, in biometric authentication, such as unlocking a mobile phone using a fingerprint, false rejections are inevitable for various reasons including the variable and noisy nature of biometric signals. Additionally, small sensors may be configured such that the entire fingerprint cannot be imaged at once. False rejections may occur simply because there is not enough fingerprint area for a confident match. False rejections may also occur for large sensors when a user misplaces her fingerprint with respect to the sensor, such as off to one side, so that only a small portion of the fingerprint is sensed. In some cases, the enrolled template may only cover a portion of the entire finger, so that subsequent verification with other portions of the finger will only have small overlap. False rejections are especially problematic for good user experience because one false rejection often leads quickly to another authentication attempt where again only a portion of the fingerprint is sensed resulting in yet another false rejection.

### SUMMARY

One embodiment of the disclosure provides a method for authenticating a user with an electronic device. The method includes acquiring a first set of biometric data during a first authentication attempt; comparing the first set of biometric data with a set of enrollment data; failing to authenticate based on the comparison of the first set of biometric data with the set of enrollment data; acquiring a second set of biometric data during a second authentication attempt, the second authentication attempt being subsequent to the first authentication attempt; comparing the second set of biometric data with the set of enrollment data; forming a match score based analysis of the first set of biometric data, the second set of biometric data and the set of enrollment data; and authenticating based on the match score.

Another embodiment of the disclosure provides a device including a biometric sensor; and a processing system. The processing system is configured to acquire a first set of biometric data during a first authentication attempt; compare the first set of biometric data with a set of enrollment data; fail to authenticate based on the comparison of the first set of biometric data with the set of enrollment data; acquire a second set of biometric data during a second authentication attempt, the second authentication attempt being subsequent to the first authentication attempt; compare the second set of biometric data with the set of enrollment data; form a match score based analysis of the first set of biometric data, the second set of biometric data and the set of enrollment data; and authenticate based on the match score.

Yet another embodiment of the disclosure provides a method for authenticating a user with an electronic device. The method includes using an enrollment template having a plurality of enrollment images. The method further includes acquiring a first fingerprint image during a first authentication attempt; comparing the first fingerprint image with the enrollment template; failing to authenticate based on the comparison of the first fingerprint image with the enrollment template; acquiring a second fingerprint image during a second authentication attempt, the second authentication attempt being subsequent to the first authentication attempt; comparing the second fingerprint image with the enrollment template; forming a match score based analysis of the first fingerprint image, the second fingerprint image and the enrollment template; and authenticating based on the match score.

Yet another embodiment of the disclosure provides a method for authenticating a user with an electronic device. The method includes acquiring a first set of biometric data during a first authentication attempt; comparing the first set of biometric data with a set of enrollment data; determining whether to authenticate based on the comparison of the first set of biometric data with the set of enrollment data; acquiring a second set of biometric data during a second authentication attempt, the second authentication attempt being subsequent to the first authentication attempt; comparing the second set of biometric data with the set of enrollment data; analyzing the first set of biometric data, the second set of biometric data and the set of enrollment data; and determining whether to authenticate based on the analysis.

### BRIEF DESCRIPTION OF THE DRAWINGS

FIG. 1 is a block diagram of an example of an input device that includes a biometric sensor and a processing system, according to an embodiment of the disclosure.

FIG. 2 is a block diagram of another example of an input device that includes a fingerprint sensor, according to an embodiment of the disclosure;

FIG. 3A-3B show a flow diagram of a method for authenticating a user using sequential matching, according to one embodiment of the disclosure;

FIG. 4A-4F illustrate a method for authenticating a user using sequential matching, according to another embodiment of the disclosure;

FIG. 5 illustrates a method for authenticating a user using sequential matching, according to another embodiment of the disclosure;

FIG. 6 illustrates a method for authenticating a user using sequential matching, according to another embodiment of the disclosure; and

FIG. 7 illustrates a method for authenticating a user using sequential matching, according to another embodiment of the disclosure.

### DETAILED DESCRIPTION

The following detailed description is exemplary in nature and is not intended to limit the disclosure or the application and uses of the disclosure. Furthermore, there is no intention to be bound by any expressed or implied theory presented in the preceding field, background, summary, brief description of the drawings, or the following detailed description.

Turning to the drawings, and as described in greater detail herein, embodiments of the disclosure provide systems and methods for sequential matching of biometric data. Instead of treating sequential authentication attempts independently, the systems and methods provide for analyzing verification data from successive attempts to reduce the false rejection rate thereby improving the user experience. In certain embodiments, a sequence (e.g, two or more) partial weak matches may lead to a false rejection when considered independently. However, when the weak matches are combined or considered together and checked for global consistency, the partial matches result in a confident match thereby permitting successful authentication.

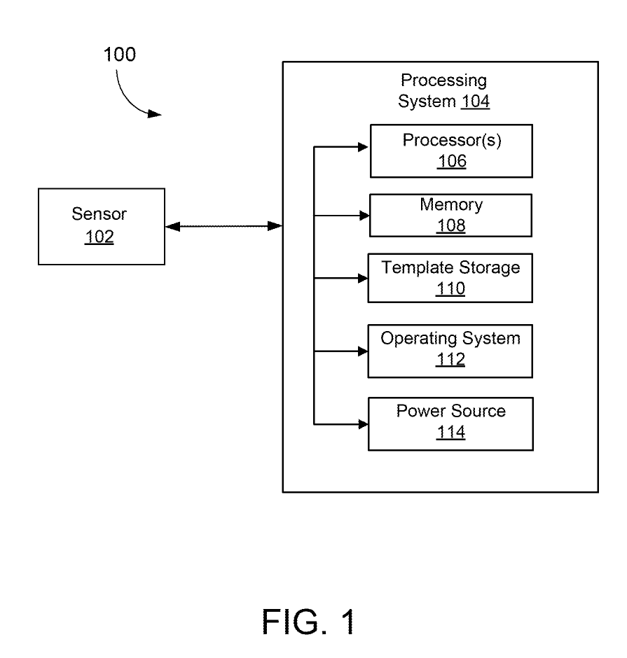

FIG. 1 is a block diagram of an example of an input device 100. The input device 100 may be configured to provide input to an electronic system (not shown). As used in this document, the term “electronic system” (or “electronic device”) broadly refers to any system capable of electronically processing information. Some non-limiting examples of electronic systems include personal computers of all sizes and shapes, such as desktop computers, laptop computers, netbook computers, tablets, web browsers, e-book readers, personal digital assistants (PDAs), and wearable computers (such as smart watches and activity tracker devices). Additional example electronic systems include composite input devices, such as physical keyboards that include input device 100 and separate joysticks or key switches. Further examples of electronic systems include peripherals such as data input devices (including remote controls and mice), and data output devices (including display screens and printers). Other examples include remote terminals, kiosks, and video game machines (e.g., video game consoles, portable gaming devices, and the like). Other examples include communication devices (including cellular phones, such as smart phones), and media devices (including recorders, editors, and players such as televisions, set-top boxes, music players, digital photo frames, and digital cameras). Additionally, the electronic system could be a host or a slave to the input device.

The input device 100 can be implemented as a physical part of the electronic system, or can be physically separate from the electronic system. As appropriate, the input device 100 may communicate with parts of the electronic system using any one or more of the following: buses, networks, and other wired or wireless interconnections. Examples include I2C, SPI, PS/2, Universal Serial Bus (USB), Bluetooth, RF, and IRDA.

A sensor 102 comprises one or more sensing elements configured to sense input provided by one or more input objects in a sensing region. Examples of input objects include biometric input objects such as fingers, hands, face, eyes (e.g., retina) and the like. The sensor may be a discrete device or may be incorporated as part of other components, such as embedded within a display.

The sensing region encompasses any space above, around, in and/or near the sensor 102 in which the input device 100 is able to detect user input (e.g., user input provided by one or more input objects). The sizes, shapes, and locations of particular sensing regions may vary from embodiment to embodiment. In some embodiments, the sensing region extends from a surface of the input device 100 in one or more directions into space until signal-to-noise ratios prevent sufficiently accurate object detection. The distance to which this sensing region extends in a particular direction, in various embodiments, may be on the order of less than a millimeter, millimeters, centimeters, or more, and may vary significantly with the type of sensing technology used and the accuracy desired. Thus, some embodiments sense input that comprises no contact with any surfaces of the input device 100, contact with an input surface (e.g. a touch surface) of the input device 100, contact with an input surface of the input device 100 coupled with some amount of applied force or pressure, and/or a combination thereof. In various embodiments, input surfaces may be provided by surfaces of sensor substrates within which or on which sensor elements are positioned, or by face sheets or other cover layers positioned over sensor elements.

The input device 100 may utilize any suitable combination of sensor components and sensing technologies to detect user input in the sensing region. Some implementations utilize arrays or other regular or irregular patterns of multiple sensing elements to detect the input. Exemplary sensing techniques that the input device 100 may use include capacitive sensing techniques, optical sensing techniques, acoustic (e.g., ultrasonic) sensing techniques, pressure-based (e.g., piezoelectric) sensing techniques, resistive sensing techniques, thermal sensing techniques, inductive sensing techniques, elastive sensing techniques, magnetic sensing techniques, and/or radar sensing techniques.

For example, the input device 100 may use resistive sensing techniques where contact from an input object closes an electrical circuit and can be used to detect input. In one exemplary technique, the sensor 105 includes a flexible and conductive first layer separated by one or more spacer elements from a conductive second layer. During operation, one or more voltage gradients are created across the layers. Pressing the flexible first layer may deflect it sufficiently to create electrical contact between the layers, resulting in voltage outputs reflective of the point(s) of contact between the layers. These voltage outputs may be used to determine spatial information corresponding to the input object.

In another example, the input device 100 may use inductive sensing techniques where one or more sensing elements pick up loop currents induced by a resonating coil or pair of coils. Some combination of the magnitude, phase, and frequency of the currents may then be used to determine spatial information corresponding to the input object.

In another example, the input device 100 may use acoustic sensing techniques where one or more acoustic sensing elements detect sound waves from nearby input objects. The sound waves may be in audible frequencies or ultrasonic frequencies. The detected sound waves may include echoes of ambient sound waves and/or echoes of sound waves emitted by the input device that are reflected from surfaces of the input object. Some combination of the amplitude, phase, frequency, and or time delay of the electrical signals may be used to determine spatial information corresponding to the input object.

One exemplary acoustic sensing technique utilizes active ultrasonic sensing to emit high frequency source waves that propagate to the sensing region. One or more ultrasonic transmitter elements (also “ultrasonic emitters”) may be used to emit high frequency sound waves to the sensing region, and one or more ultrasonic receiving elements (also “ultrasonic receivers”) may detect echoes of the emitted sound waves. Separate elements may be used to transmit and receive, or common elements that both transmit and receive may be used (e.g., ultrasonic transceivers). In some instances, emitted ultrasonic waves are able to penetrate sub-surfaces of the input object, such as dermal layers of a human finger.

In another example, the input device 100 may use optical sensing techniques where one or more sensing elements detect light from the sensing region. The detected light may be reflected from the input object, transmitted through the input object, emitted by input object, or some combination thereof. The detected light may be in the visible or invisible spectrum (such as infrared or ultraviolet light). Example optical sensing elements include photodiodes, CMOS image sensor arrays, CCD arrays, photodiodes, and other suitable photosensors sensitive to light in wavelength(s) of interest. Active illumination may be used to provide light to the sensing region, and reflections from the sensing region in the illumination wavelength(s) may be detected to determine input information corresponding to the input object.

One exemplary optical technique utilizes direct illumination of the input object, which may or may not be in contact with an input surface of the sensing region depending on the configuration. One or more light sources and/or light guiding structures are used to direct light to the sensing region. When an input object is present, this light is reflected directly from surfaces of the input object, which reflections can be detected by the optical sensing elements and used to determine input information about the input object.

Another exemplary optical technique utilizes indirect illumination based on internal reflection to detect input objects in contact with an input surface of the sensing region. One or more light sources are used to direct light in a transmitting medium at an angle at which it is internally reflected at the input surface of the sensing region, due to different refractive indices at opposing sides of the interface defined by the input surface. Contact of the input surface by the input object causes the refractive index to change across this boundary, which alters the internal reflection characteristics at the input surface. Higher contrast signals can often be achieved if principles of frustrated total internal reflection (FTIR) are used to detect the input object, where the light is directed to the input surface at an angle of incidence at which it is totally internally reflected, except at locations where the input object is in contact and causes the light to partially transmit across this interface. An example of this is presence of a finger introduced to an input surface defined by a glass to air interface. The higher refractive index of human skin compared to air causes light incident at the input surface at the critical angle of the interface to air to be partially transmitted through the finger, where it would otherwise be totally internally reflected at the glass to air interface. This optical response can be detected by the system and used to determine spatial information. In some embodiments, this can be used to image small scale surface variations of the input object, such as fingerprint patterns, where the internal reflectivity of the incident light differs depending on whether a ridge or valley of the finger is in contact with that portion of the input surface.

In another example, the input device 100 may use capacitive techniques where voltage or current is applied to create an electric field. Nearby input objects cause changes in the electric field, and produce detectable changes in capacitive coupling that may be detected as changes in voltage, current, or the like. Sensor electrodes may be utilized as capacitive sensing elements. Arrays or other regular or irregular patterns of capacitive sensing elements may be used to create electric fields. Separate sensor electrodes may be ohmically shorted together to form larger sensing elements.

One exemplary technique utilizes “self capacitance” (or “absolute capacitance”) sensing methods based on changes in the capacitive coupling between sensor electrodes and an input object. An input object near the sensor electrodes alters the electric field near the sensor electrodes, thus changing the measured capacitive coupling. An absolute capacitance sensing method may operate by modulating sensor electrodes with respect to a reference voltage (e.g. system ground), and by detecting the capacitive coupling between the sensor electrodes and the input object. For example, the sensing element array may be modulated, or a drive ring or other conductive element that is ohmically or capacitively coupled to the input object may be modulated. The reference voltage may by a substantially constant voltage or a varying voltage, or the reference voltage may be system ground.

Another exemplary technique utilizes “mutual capacitance” (or “transcapacitance”) sensing methods based on changes in the capacitive coupling between sensor electrodes. An input object near the sensor electrodes may alter the electric field between the sensor electrodes, thus changing the measured capacitive coupling. A transcapacitive sensing method may operate by detecting the capacitive coupling between one or more transmitter sensor electrodes (also “transmitter electrodes”) and one or more receiver sensor electrodes (also “receiver electrodes”). Transmitter sensor electrodes may be modulated relative to a reference voltage to transmit transmitter signals. Receiver sensor electrodes may be held substantially constant relative to the reference voltage to facilitate receipt of resulting signals. The reference voltage may by a substantially constant voltage or system ground. The transmitter electrodes are modulated relative to the receiver electrodes to transmit transmitter signals and to facilitate receipt of resulting signals. A resulting signal may comprise effect(s) corresponding to one or more transmitter signals, and/or to one or more sources of environmental interference (e.g. other electromagnetic signals). Sensor electrodes may be dedicated transmitters or receivers, or may be configured to both transmit and receive. Also, sensor electrodes may be dedicated transcapacitance sensing elements or absolute capacitance sensing elements, or may be operated as both transcapacitance and absolute capacitance sensing elements.

The electronic system 100 that includes a processing system 104, according to an embodiment of the disclosure. By way of example, basic functional components of the electronic device 100 utilized during capturing, storing, and validating a biometric match attempt are illustrated. The processing system 104 includes a processor(s) 106, a memory 108, a template storage 110, an operating system (OS) 112, and a power source(s) 114. Each of the processor(s) 106, the memory 108, the template storage 110, and the operating system 112 are interconnected physically, communicatively, and/or operatively for inter-component communications. The power source 114 is interconnected to the various system components to provide electrical power as necessary.

As illustrated, processor(s) 106 are configured to implement functionality and/or process instructions for execution within electronic device 100 and the processing system 104. For example, processor 106 executes instructions stored in memory 108 or instructions stored on template storage 110 to identify a biometric object or determine whether a biometric authentication attempt is successful or unsuccessful. Memory 108, which may be a non-transitory, computer-readable storage medium, is configured to store information within electronic device 100 during operation. In some embodiments, memory 108 includes a temporary memory, an area for information not to be maintained when the electronic device 100 is turned off. Examples of such temporary memory include volatile memories such as random access memories (RAM), dynamic random access memories (DRAM), and static random access memories (SRAM). Memory 108 also maintains program instructions for execution by the processor 106.

Template storage 110 comprises one or more non-transitory computer-readable storage media. In the context of a fingerprint sensor, the template storage 110 is generally configured to store enrollment views for fingerprint images for a user's fingerprint or other enrollment information. More generally, the template storage 110 may be used to store information about an object. The template storage 110 may further be configured for long-term storage of information. In some examples, the template storage 110 includes non-volatile storage elements. Non-limiting examples of non-volatile storage elements include magnetic hard discs, solid-state drives (SSD), optical discs, floppy discs, flash memories, or forms of electrically programmable memories (EPROM) or electrically erasable and programmable (EEPROM) memories, among others.

The processing system 104 also hosts an operating system (OS) 112. The operating system 112 controls operations of the components of the processing system 104. For example, the operating system 112 facilitates the interaction of the processor(s) 106, memory 108 and template storage 110.

According to various embodiments, the processor(s) 106 implement hardware and/or software to obtain data describing an image of an input object. The processor(s) 106 may also align two images and compare the aligned images to one another to determine whether there is a match. The processor(s) 106 may also operate to reconstruct a larger image from a series of smaller partial images or sub-images, such as fingerprint images when multiple partial fingerprint images are collected during a biometric process, such as an enrollment or matching process for verification or identification.

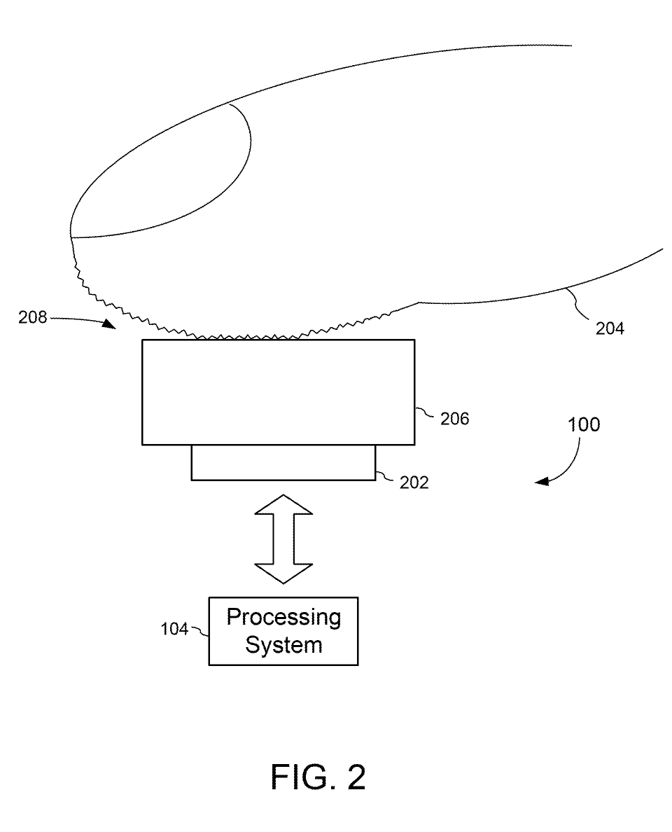

FIG. 2 depicts a further example of an input device 100 wherein the input device includes a fingerprint sensor 202. The fingerprint sensor 202 is configured to capture a fingerprint from a finger 204. The sensor 202 is disposed underneath a cover layer 206 that provides an input surface for the fingerprint to be placed or swiped over the sensor 202. Sensing region 208 may include an input surface with an area larger than, smaller than, or similar in size to a full fingerprint. The fingerprint sensor 202 is configured to detect surface variations of the finger 204, and the fingerprint sensor 202 has a relatively high resolution capable of resolving features (e.g., ridges and valleys) of a fingerprint placed on the input surface.

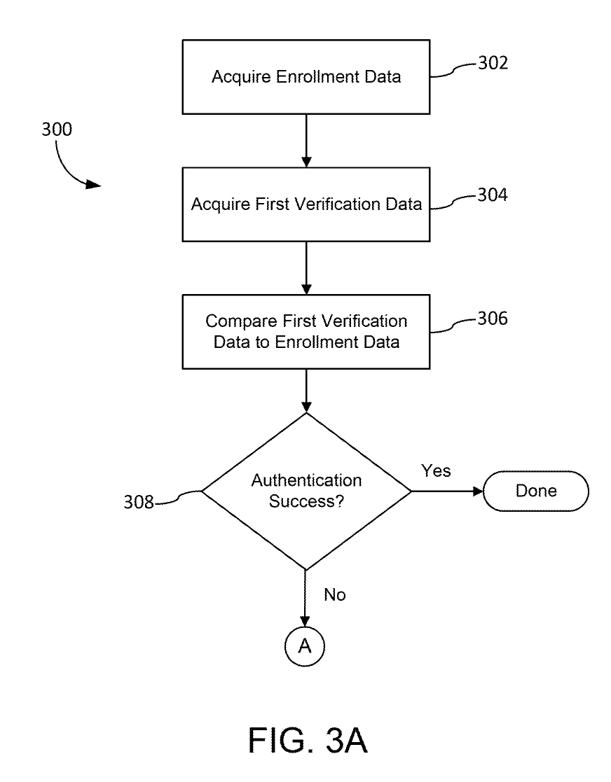

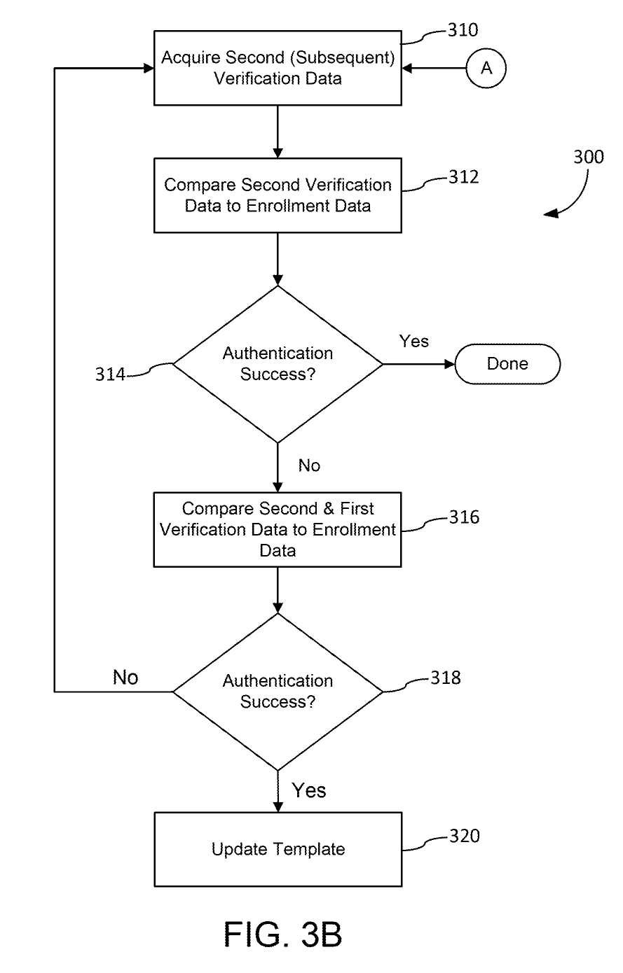

FIG. 3A-3B illustrate an example of a method 300, which may be used in conjunction with input device 100, for authenticating, or more generally matching biometric data, of a user employing sequential matching according to the present disclosure. It will be understood that the various steps shown are by way of illustration. Other steps may included, steps may be eliminated and/or the sequence shown and described may vary expect where otherwise apparent. Certain non-limiting variations are set forth in the description which follows.

In step 302, a device, such as input device 100, acquires biometric enrollment data for a user during an enrollment process. The nature of the enrollment data will depend on the type of biometric to be imaged, e.g., finger, hands, face, retina and the like and the type of sensor 102 used. The biometric enrollment data may be of any suitable form, such as for example, images and/or measurements. In the case of a fingerprint, for example, the biometric enrollment data may include an image of an entire fingerprint or a series of partial fingerprint images. The partial fingerprint images may then be combined or stitched together. Alternatively, the partial fingerprint images may be related by way of a template map.

The acquired enrollment data may be subjected to further processing. For example, biometric images may be subjected to feature extraction. In the case of fingerprint images, the images or partial images may be processed to extract ridge skeletons, minutia points, ridge flows, sweat pores, or other feature sets. Once acquired, and processed (if applicable), the enrollment data is typically stored in an enrollment template for use in later user authentication attempts. It will be understood that the enrollment process need only occur once for a given user, although periodic updating of the enrollment template may occur either during a subsequent enrollment process or as part of automatic updating.

In step 304, first verification biometric data is acquired from a user during a first authentication attempt. The verification data will generally be of the same biometric as the enrollment data (e.g., finger, hand, face or retina) and of the same type (e.g., image and/or measurement). Like the enrollment data, the verification data may be subjected to image processing including feature extraction.

In step 306, the first verification data is compared to the enrollment data, e.g., one or more partial views. In general, the purpose of the comparison is to determine if a confident match exists. Various methods can be used to determine whether a confident match exists. For example, in the context of fingerprint biometric sensing, a partial fingerprint image taken during an authentication attempt (verification image) is compared to one or more partial images in an enrollment template (enrollment images). Potential matches may be determined by comparing feature sets of the verification image to the enrollment images. The feature sets used during this comparative process may, for example, include comparisons of minutia points, ridges and the like. Alternatively, or in combination therewith, amount or percentage of areas of overlap between the verification image and enrollment images can be ascertained with larger areas of overlap corresponding to greater confidence in a match. The results of the comparison may then be converted to a match score with certain scores being indicative of a greater level of confidence that a match is found. For example, a higher score may correspond to a greater level of confidence, although such direct correlation is unnecessary.

In step 308, the method 300 determines if the authentication attempt is successful. As noted, the authentication attempt is successful if a confident match is found between the verification data and the enrollment data. The determination at step 308 may be based, for example, on whether the match score exceeds a threshold value. If the first authentication attempt results in sufficiently high confidence that a match is found to authenticate, the process may simply conclude as generally shown. However, even if the process concludes, the first verification data and/or match score may be used as part of subsequent authentication as described further below.

In other instances, sufficient confidence of a match will not exist to authenticate the user. In accordance with the disclosure, such instances need not result in an automatic complete failure of the authentication process. For example, as shown in step 310 (FIG. 3B), second verification biometric data may be acquired from the user during a second authentication attempt where the second authentication attempt is subsequent to the first authentication attempt. As a specific example, a second partial fingerprint image is obtained. The second partial fingerprint image may be obtained by prompting the user for a second imaging attempt or may simply be initiated by the user when the first attempt proves unsuccessful.

In steps 312, the second verification data alone may be compared the enrollment data, i.e., the second verification data may be compared to the enrollment data without consideration of the first verification data. A determination of whether a confident match exists is then made at step 314. The determination may be based on whether the comparison at step 312 results in a match score that exceeds a threshold. The case may be that the second verification data is sufficient in and of itself for authentication, e.g, a comparison of the second verification data to the enrollment data may result in sufficient confidence that a match is exists to authenticate the user. In such instances, the process may simply conclude, although any match score and second verification data may be retained for future use. In other instances, however, the comparison of the second verification data to the enrollment data will also fall short of the necessary threshold to establish a confident match.

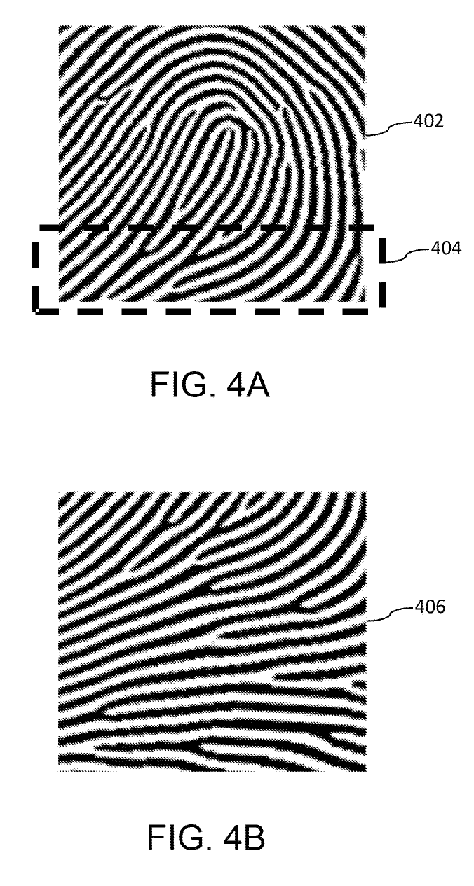

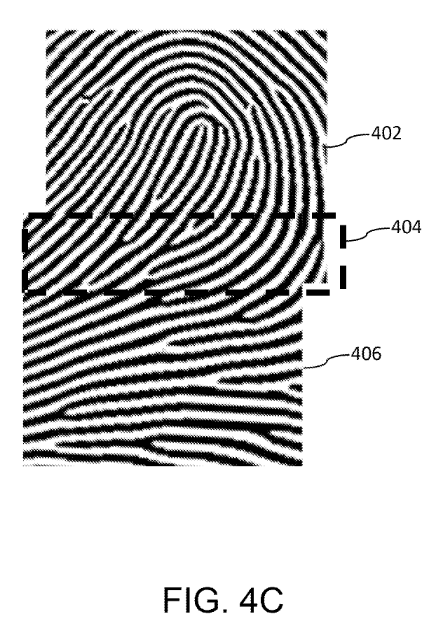

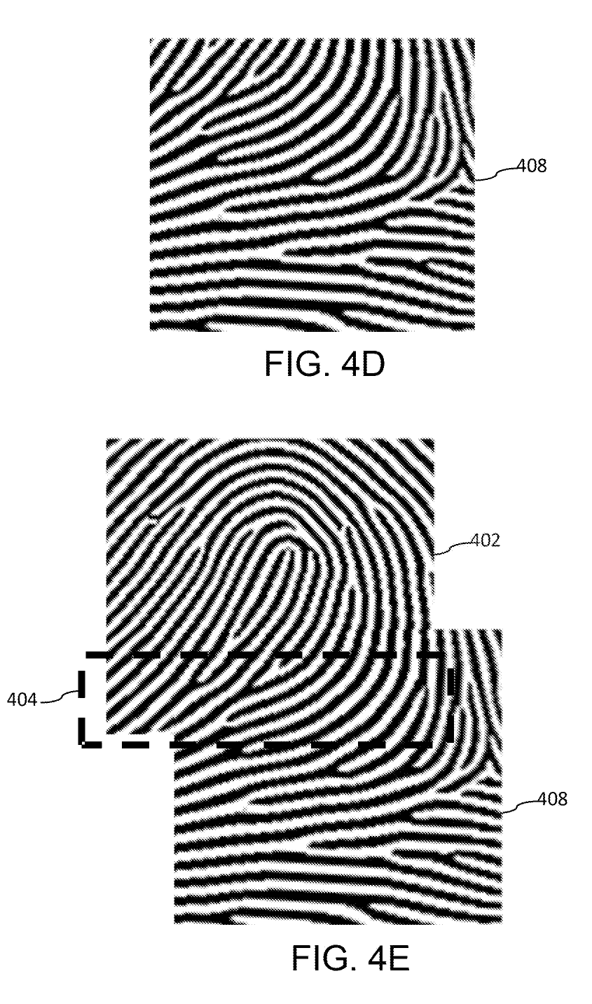

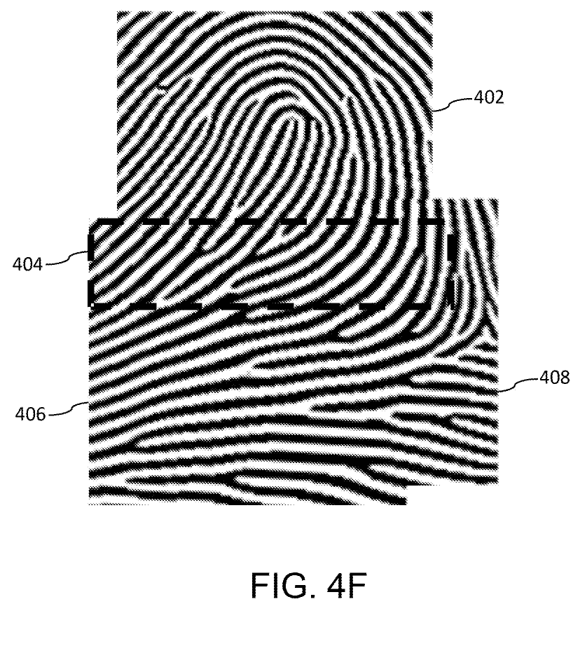

In step 316, the first and second verification data and the enrollment data are globally compared and analyzed in an attempt to successfully authenticate. The comparison at step 316 may be accomplished in a variety of ways. For example, if scores were obtained during the first and second authentication attempts, the scores can be combined, converted or merged into a single score. The single score can then be used to determine if a confident match exits. Alternatively, or in combination, if areas of image or data overlap were analyzed during the first and second authentication attempts, total area of overlap of the first and second verification data with the enrollment data can be determined. The total area of overlap can then be used to determine if a confident match exits (see, e.g., FIG. 4F). As yet another variation, the first and second verification data can be stitched together, or otherwise combined, and then compared to the enrollment data.

In addition to comparing the first and second verification data with the enrollment data, it is also possible in accordance with the present disclosure to optionally adjust the confidence of a match by comparing the first verification data with the second verification data. For example, relative geometry or transformation (e.g., translation and rotation) of the first verification data relative to the enrollment data can be ascertained in instances of partial match. Similarly, relative geometry or transformation of the second verification data relative to enrollment data can be ascertained. Based on such comparisons, it can be predicted whether the first verification data and second verification data should overlap with each other and, if so, where the overlap should exist as well as whether there is relative rotation between the first and second verification data. In this manner, a comparison of the first verification data with the second verification data can increase or decrease confidence depending on whether the comparison is consistent or inconsistent with predicted results.

For example, assume a comparison of the first verification data with the enrollment data and comparison of the second verification data with the enrollment data suggests that the first verification data should overlap with the second verification data. If a comparison of the first verification data with the second verification data shows the predicted overlap, confidence of a match (e.g., score) is increased. Conversely, if no overlap is found as a result of the comparison, the confidence (e.g., score) is decreased.

More generally, the method contemplates at step 316 determining the overall consistency and matching between the first verification data, the second verification data and the enrollment data. Other examples are illustrated as follows where:

TABLE 1

| Variable | Definition |
|---|---|
| V₁ | first verification data |
| V₂ | second verification data |
| E | enrollment data |
| T_{V1:E} | transformation (e.g., rotation and translation) between V₁ and |
| | E |
| T_{V2:E} | transformation (e.g., rotation and translation) between V₂ and |
| | E |
| S_{V1:E} | match score between V₁ and E |
| S_{V2:E} | match score between V₂ and E |
| T_{V1:V2} | transformation (rotation and translation) between V₁ and V₂ |
| S_{V1:V2} | match score between V₁ and V₂ |
| T_{V1:E:V2} | composed transformation between V₁ and V₂ determined from |
| | T_{V1:E} and T_{V2:E} |
| S_{V1:V2} | match score between V₁ and V₂ |
| S_{V1+V2:E} | match score between E and a combination of V₁ and V₂ |

By way of illustration, in one example, S_{V1+V2:E} is determined by aligning V₁ to E and V₂ to E and then determining a match score based on comparisons of V₁ to E and V₂ to E. In this example, a match score (S_{V1,E}) between V₁ and E may have been calculated during a previous authentication attempt. S_{V1+V2:E} may be directly determined during the comparison of V₂ to E by using a function that incorporates S_{V1:E}. S_{V1:V2} need not be determined, although it may optionally be determined to adjust the confidence of a match.

In another example, S_{V1+V2:E} is determined by combining (e.g., stitching together) V₁ and V₂. The match score (S_{V1+V2:E}) is then computed by comparing the combined data (V₁+V₂) to the enrollment data (E). Again, S_{V1:V2} need not be determined, although it may optionally be determined to adjust the confidence of a match.

In yet another example, V₁ is directly compared to V₂ to check for consistency. For example:
a. compare V₁ to V₂ directly to compute T_{V1:V2}; compare T_{V1:E:V2} and T_{V1:V2} to check for consistency (for example, check whether they are in a tolerance of each other).
b. compare V₁ to V₂ directly to compute S_{V1:V2}. Use S_{V1:V2} to check for consistency (for example, check whether S_{V1:V2} is sufficiently high).
   i. compare V₁ to V₂ directly to compute T_{V1:V2}, which is used to align V₁ to V₂.
   ii. use T_{V1:E:V2} to align V₁ to V₂, then compute S_{V1:V2}. This can allow for faster computation compared to (i) (e.g., alignment may be a time consuming step in the matching process), and also provide extra confidence since using T_{V1:E:V2} for the match score S_{V1:V2} assumes geometric consistency.
   iii. compare V₁ to V₂ directly to compute S_{V1:V2} using a distance metric that does not require image alignment.

Those skilled in the art will appreciate that other variations may be used. The point is to check for global consistency as part of the comparison process.

A determination of whether authentication is successful based on such comparison occurs at step 318. The determination may be based on analysis of the comparisons of the first verification data and enrollment data, comparisons of the second verification data and the enrollment data, and may further include comparison of the first verification data and the second verification data as describe above. If the analysis exceeds a desired threshold or metric, the authentication is successful. Otherwise the authentication fails. If the authentication fails, the process may loop back to step 310 where further subsequent verification data is collected. The process may loop as many times as described and each iteration of the loop may take into account all or some subset of the verification data previously acquired.

In step 320, the enrollment data in the enrollment template may be updated. The enrollment data may be updated by, for example, adding information found in one or more of the verification data sets acquired. For example, if authentication is granted based on the first and second verification data, data from one or both of the first and second verification data may be added to the enrollment template if not already contained within the enrollment data. This may occur if the first or second verification data only partially overlaps the enrollment data. Updating may also be appropriate where the data from the first or second verification data sets is more complete, e.g., contain minutia points, ridge data, etc. not found in the enrollment data.

The system and method described advantageously increase the confidence level with respect to whether or not there is match, while at the same time decreasing the FRR. Thus, user experience is improved without sacrificing system security.

As noted above, variations of the process of FIGS. 3A-3B are contemplated by the present disclosure that includes the elimination, modification or re-sequencing of certain steps. For example, it is not necessary to perform an authentication comparison at step 306 and 308. Instead, two sets of verification data can be obtained before authentication is analyzed. Thus, increased confidence of a match/no match can be realized without a first failed attempt. Further, an isolated comparison of the second verification data to the enrollment data need not be performed and instead the first and second verification data can be merged or otherwise collectively considered at the outset. Thus, steps 312 and 314 may similarly be eliminated.

The system method further contemplates the use of sequential matching for persistent authentication. In persistent authentication, the system continuously or regularly authenticates the user while the user is using the device after a successful authentication. The continuous or regular authentication ensures the device continues to be used by an authorized user. Once authentication is successful, subsequent authentication decisions may be made based on the prior verification data in conjunction with subsequently acquired verification data. The subsequent authentication decision may be done passively while the user is using the device (e.g., the subsequent authentication may be conducted in the background without prompting or notifying the user) or may be active (e.g., the user may be prompted to authenticate). The subsequent authentication decision may or may not be done with a different threshold or metric (e.g., match score) than the first authentication attempt. The subsequent authentication attempts may or may not be done in multiple instances using, for example, a rolling window, which repeatedly looks to a previous authentication attempt, or a subset of previous authentication attempts. For example, the subsequent authentication may examine the previous N authentication attempts, previous authentication attempts within a certain time window T, or an initial authentication attempt that might be a stronger biometric match or have been subjected to a more stringent authentication requirement than the subsequent passive/persistent authentication attempts. In all the foregoing examples, current verification data is examined in conjunction with prior authentication attempts to arrive at a level confidence, e.g. match score, in an effort to authenticate.

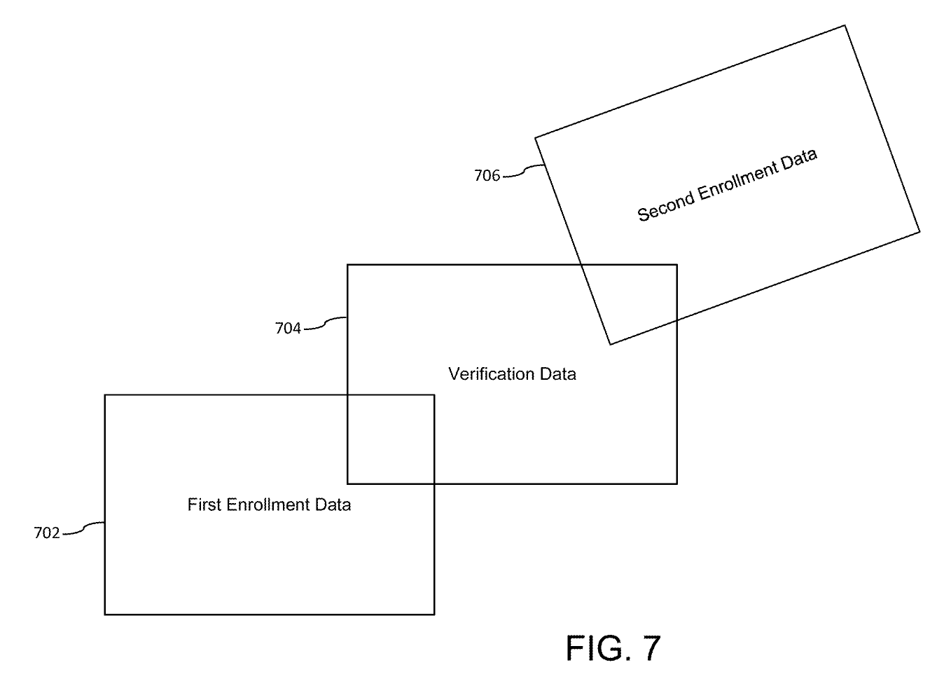

Moreover, as described in connection with the example of FIG. 7, instead of obtaining second verification data, the first verification data can be compared to additional enrollment data, such as a second enrollment image. Thus, the process and system more generally relate to obtaining at least three pieces of data rather than just two as part of establishing a level of confidence of a match in an authentication process. Such pieces may include at least two sets of verification data and one set of enrollment data or, alternatively, one set of verification data and at least two sets of enrollment data

The process described in connection with FIGS. 3A-3B will now be described with reference to certain non-limiting examples as shown and described in FIG. 4A-FIG. 7.

FIGS. 4A-4F illustrate an example of sequential matching in the specific context of fingerprint imaging. FIG. 4A shows a partial fingerprint image 402, which illustratively depicts an enrollment image contained in an enrollment template. In the example, dark portions generally correspond to ridges while the lighter areas generally correspond to valleys. Area 404, shown by a rectangular area bounded by a dashed line, represents an example of the minimum area of overlap required for a confident match to be found. Of course, it will be understood that the placement of area 404 is merely one example. Area 404 could be placed at other locations within the enrollment image 402. For example, the area 404 could be any area of the image 402 of substantially the same size. Moreover, the area of overlap required for a confident match may be more or less depending on the particular application.

FIG. 4B shows a first partial verification fingerprint image 406 acquired as first verification data during an authentication attempt, such as described in step 304 (FIG. 3A). As described in step 306, the verification image 406 is compared to the enrollment template, which in this case includes enrollment image 402. The result of the comparison is illustratively shown in FIG. 4C. As will be apparent, overlap exists between verification image 406 and enrollment image 402. However, the overlap falls short of the area required, i.e., the area of overlap does not fully fill area 404. Thus insufficient confidence exists to confirm a valid authentication attempt.

FIG. 4D shows a second partial verification fingerprint image 408 acquired during a second authentication attempt, taken subsequent to the first authentication attempt (see step 310). FIG. 4E illustrates the comparison of the second verification image 408 with the enrollment image 402 and the resulting overlap. As with the comparison between the first verification image 406 and enrollment image 402, overlap exists between the second verification image 408 and enrollment image 402; however, the area of overlap again falls short of filling area 404 and thus provides insufficient confidence to confirm valid authentication.

In accordance with certain variations of the process described in connection with FIGS. 3A-3B, the combined first 406 and second 408 verification images is then compared to the enrollment image 402 in an effort to authenticate using sequential matching (see steps 316-318). This may be done, by for example, providing a match score for each comparison described in connection with FIGS. 4C and 4E and then combining the match scores or otherwise deriving a collective score to determine if the necessary area of overlap or other threshold is met. Alternatively, images 406 and 408 can be combined and the combined image can be compared to the enrollment image 402 as shown in FIG. 4F. In the example shown, verification images 406 and 408 collectively overlap the entirety of area 404 and, therefore, provide sufficient confidence of a match.

Further, verification images 406 and 408 may optionally be compared to each other to potentially adjust the confidence of a match. For example, based on the geometry of verification image 406 as compared to enrollment image 402, and based on the geometry of verification image 408 compared to enrollment image 402, it would be predicted that overlap will be found between verification image 406 and verification image 408. If upon a comparison of verification image 406 and verification image 408, overlap is found, the confidence of a match may be increased. Conversely, if no overlap is found, the confidence may be decreased.

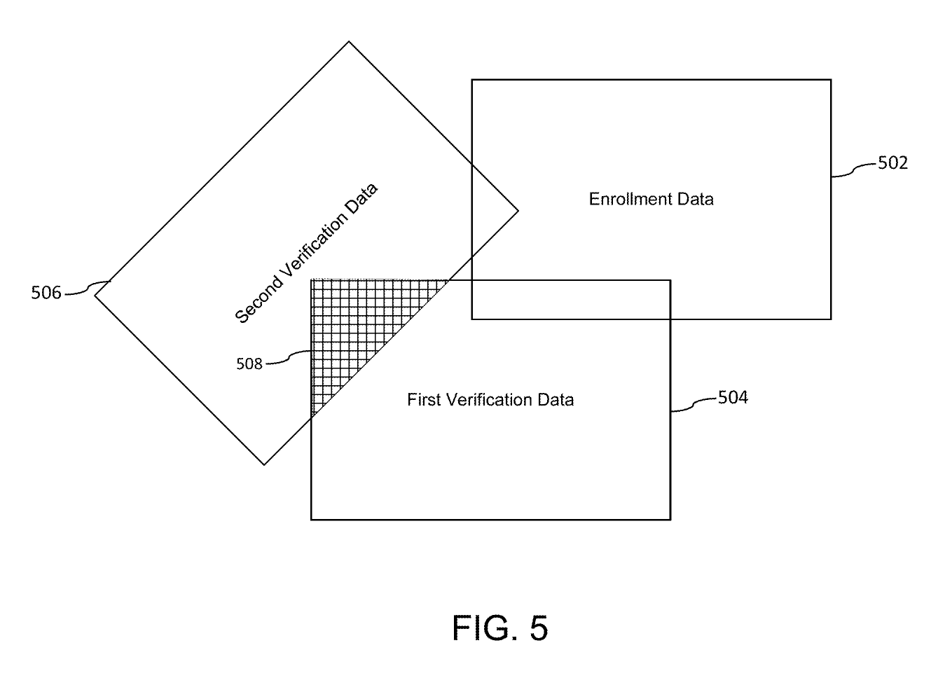

FIG. 5 illustrates another example of sequential matching in the context of biometric data generally. In the example, box 502 represents a set of enrollment data and boxes 504 and 506 represent a set of verification biometric data from first and second authentication attempts, respectfully. It is assumed for purposes of the example that a first comparison of first verification data 504 with enrollment data 502 is insufficient to establish a match. It is further assumed that a second comparison of second verification data 506 with enrollment data 502 is likewise insufficient to establish a match. Combining individual scores or areas of overlap from the first and second comparisons may be sufficient to establish a confident match. Alternatively, combining the first 504 and second verification data 506 and then comparing to the enrollment data 502 may be sufficient to establish a match.

Moreover, analysis of the geometries or transformation (e.g., relative rotation and translation) of the first verification data 504 relative to the enrollment data 502 and the second verification data 506 relative to the enrollment data 502 can be performed to anticipate the relative geometry or transformation between the first verification data 504 and the second verification data 506. Thus, in FIG. 5, for example, it is assumed that region 508 will be an area of overlap between verification data 504 and verification data 506. If a comparison between verification data 504 and verification data 506 shows area 508 as an area of overlap, the confidence of a match (e.g, score) is accordingly adjusted (e.g., increased). Conversely, if the comparison of verification data 504 and verification data 506 fails to show area 508 as an area of overlap, the confidence of a match is accordingly adjusted (e.g., decreased).

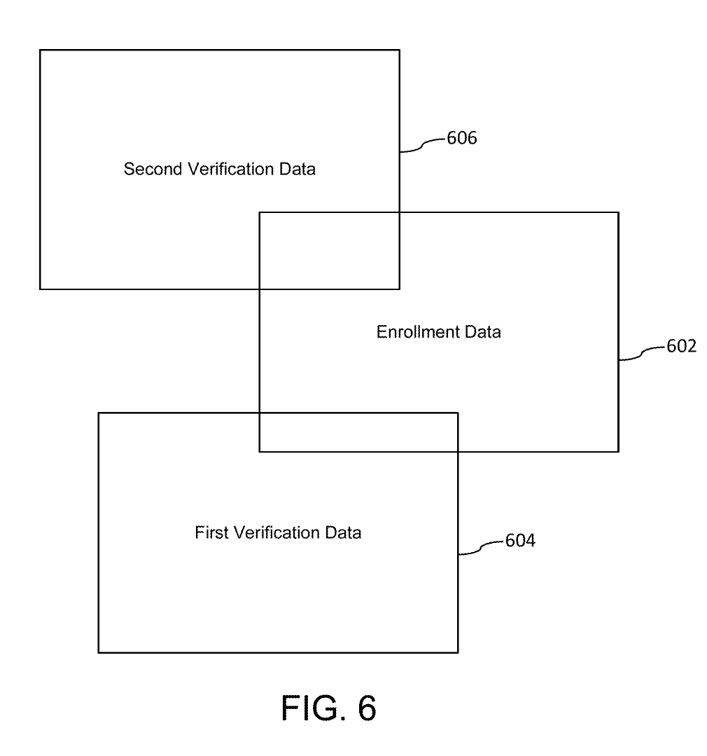

FIG. 6 illustrates yet another example of sequential matching. Box 602 represents a set of enrollment data and box 604 and box 606 represent sets of verification data from first and second authentication attempts, respectively. Like FIG. 5, it is assumed that a comparison of first verification data 604 with enrollment data 602 is insufficient to establish a confident match and that a comparison of second verification data 606 with enrollment data 602 is likewise insufficient. Thus, in accordance with the disclosure, both first verification data 604 and second verification data 606 are analyzed relative to the enrollment data 602 to determine if a confident match can be found.

Moreover, analysis of the geometrics or transformations (e.g., relative rotation and translation) of the first verification data 604 relative to the enrollment data 602 and the second verification data 606 relative to the enrollment data 602 can be performed to optionally predict the relative geometry or transformation between the first verification data 604 and the second verification data 606. Thus, in the example of FIG. 6, it is predicted no region of overlap will be found when verification data 604 and is compared to verification data 606. Thus, if a comparison between the first verification data 604 and the second verification data 606 shows an area of overlap (inconsistent with the prediction), the confidence of a match (e.g, score) is decreased. On the other hand, if the comparison of the first verification data 604 and the second verification data 606 fails to show any area of overlap (consistent with the prediction), the confidence of a match is increased.

It will be understood that FIGS. 5-6 were each described in connection with a direct comparison between the first and second verification data. As described in connection with FIGS. 3A-3B, the direct comparison between the first and second verification data is optional analysis that may be performed as part of step 316, for example. The method also contemplates relying on the collective analysis of the comparison of (1) the first verification data to the enrollment data and (2) the second verification data and the enrollment data without consideration of the comparison of the first verification data to the second verification data.

FIG. 7 illustrates a variation on the methodology of FIG. 3 wherein instead of analyzing verification data from multiple authentication attempts to a single set of enrollment data, verification data from one or more authentication attempts is analyzed against multiple sets of enrollment data.

In the example, box 702 represents first set of enrollment data and box 704 represents verification data from an authentication attempt. It is assumed that a comparison of enrollment data 702 with verification data 704 is insufficient to establish a match. In this example, the verification data 704 may then be compared to a second set of enrollment data 706. The combined results from both comparisons may be sufficient to establish enough confidence to establish a match. The level of confidence can be increased if the geometry or transformation (rotation and translation) of the second enrollment data 706 is known relative to the first enrollment data 702. In such cases, it can be predicted if the verification data 704 will overlap with the second enrollment data 706 and, if so, where the overlap region is expected to occur. The level of confidence of a match may be increased or decreased depending upon whether the results of the comparison between verification data 704 and second enrollment data 706 are consistent or inconsistent with the predicted results.

The embodiments and examples set forth herein were presented in order to best explain the present disclosure and its particular application and to thereby enable those skilled in the art to make and use the invention. However, those skilled in the art will recognize that the foregoing description and examples have been presented for the purposes of illustration and example only. The description as set forth is not intended to be exhaustive or to limit the invention to the precise form disclosed. For example, although certain embodiments were described with respect to fingerprint biometric imaging, the systems and methods are applicable to other biometric authentication including hand or palm prints, facial recognition, retinal scans and the like.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Certain embodiments are described herein. Variations of those embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, embodiments of the invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method for authenticating a user with an electronic device, comprising:
acquiring a first set of biometric data during a first authentication attempt;
comparing the first set of biometric data with a set of enrollment data;
failing to authenticate based on the comparison of the first set of biometric data with the set of enrollment data;
acquiring a second set of biometric data during a second authentication attempt, the second authentication attempt being subsequent to the first authentication attempt;
comparing the second set of biometric data with the set of enrollment data;
forming a match score based analysis of the first set of biometric data, the second set of biometric data and the set of enrollment data; and
authenticating based on the match score.

2. The method of claim 1, wherein the first set of biometric data comprises a first fingerprint image and the second set of biometric data comprises a second fingerprint image.

3. The method of claim 2, wherein the set of enrollment data includes a plurality of enrollment images, further comprising:
comparing the first fingerprint image to a first enrollment image of the plurality of enrollment images;
comparing the second fingerprint image to the first enrollment image; and
comparing at least one of the first and second fingerprint images to a second enrollment image of the plurality of enrollment images.

4. The method of claim 1, wherein the match score is formed based on a comparison of the first set of biometric data with the set of enrollment data, a comparison of the second set of biometric data with the set of enrollment data, and a comparison of the first set of biometric data with the second set of biometric data.

5. The method of claim 1, further comprising:
failing to authenticate based on the comparison of the second set of biometric data with the set of enrollment data;
after failing to authenticate based on the comparison of the second set of biometric data with the set of enrollment data, forming the match score based analysis of the first set of biometric data, the second set of biometric data and the set of enrollment data.

6. The method of claim 1, wherein forming the match score based analysis of the first set of biometric data, the second set of biometric data and the set of enrollment data comprises:
combining the first set of biometric data with the second set of biometric data;
comparing of the combined first and second biometric data with the enrollment data;
determining the match score at least in part based on the comparison of the combined first and second biometric data with the enrollment data.

7. The method of claim 1, further comprising:
updating, in response to authenticating based on the match score, the set of enrollment data to include portions of the first or second set of biometric data.

8. A device comprising:
a biometric sensor; and
a processing system configured to:
acquire a first set of biometric data during a first authentication attempt;
compare the first set of biometric data with a set of enrollment data;
fail to authenticate based on the comparison of the first set of biometric data with the set of enrollment data;
acquire a second set of biometric data during a second authentication attempt, the second authentication attempt being subsequent to the first authentication attempt;
compare the second set of biometric data with the set of enrollment data;
form a match score based analysis of the first set of biometric data, the second set of biometric data and the set of enrollment data; and
authenticate based on the match score.

9. The device of claim 8, wherein the set of enrollment data includes a plurality of enrollment images, the first set of biometric data comprises a first fingerprint image and the second set of biometric data comprises a second fingerprint image and the processor is further configured to:
compare the first fingerprint image to a first enrollment image of the plurality of enrollment images;
compare the second fingerprint image to the first enrollment image; and
compare at least one of the first and second fingerprint images to a second enrollment image of the plurality of verification images.

10. The device of claim 8, wherein the match score is formed based on a comparison of the first set of biometric data with the set of enrollment data, a comparison of the second set of biometric data with the set of enrollment data, and a comparison of the first set of biometric data with the second set of biometric data.

11. The device of claim 8, wherein the match score is formed by combining the first set of biometric data with the second set of biometric data; comparing of the combined first and second biometric data with the enrollment data; and determining the match score at least in part based on the comparison of the combined first and second biometric data with the enrollment data.

12. The device of claim 8, wherein the processor is further configured to:
fail to authenticate based on the comparison of the second set of biometric data with the set of enrollment data;
after failing to authenticate based on the comparison of the second set of biometric data with the set of enrollment data, form the match score based analysis of the first set of biometric data, the second set of biometric data and the set of enrollment data.

13. A method for authenticating a user with an electronic device, using an enrollment template having a plurality of enrollment images, comprising:
acquiring a first fingerprint image during a first authentication attempt;
comparing the first fingerprint image with the enrollment template;
failing to authenticate based on the comparison of the first fingerprint image with the enrollment template;
acquiring a second fingerprint image during a second authentication attempt, the second authentication attempt being subsequent to the first authentication attempt;
comparing the second fingerprint image with the enrollment template;
forming a match score based analysis of the first fingerprint image, the second fingerprint image and the enrollment template; and
authenticating based on the match score.

14. The method of claim 13, further comprising:
comparing the first fingerprint image to a first enrollment image of the plurality of enrollment images;
comparing the second fingerprint image to the first enrollment image; and
comparing at least one of the first and second fingerprint images to a second enrollment image of the plurality of enrollment images.

15. The method of claim 13, wherein the match score is formed based on a comparison of the first fingerprint image with the enrollment template, a comparison of the second fingerprint image with the enrollment template, and a comparison of the first fingerprint image with the second fingerprint image.

16. The method of claim 13, further comprising:
failing to authenticate based on the comparison of the second fingerprint image with the enrollment template;
after failing to authenticate based on the comparison of the second fingerprint image with the enrollment template, forming the match score based analysis of the first fingerprint image, the second fingerprint image and the enrollment template.

17. A method for authenticating a user with an electronic device, comprising:
acquiring a first set of biometric data during a first authentication attempt;
comparing the first set of biometric data with a set of enrollment data;
determining whether to authenticate based on the comparison of the first set of biometric data with the set of enrollment data;
acquiring a second set of biometric data during a second authentication attempt, the second authentication attempt being subsequent to the first authentication attempt;
comparing the second set of biometric data with the set of enrollment data;
analyzing the first set of biometric data, the second set of biometric data and the set of enrollment data; and
determining whether to authenticate based on the analysis.

18. The method of claim 17, wherein the determination of whether to authenticate based on the comparison of the first set of biometric data with the set of enrollment data results in a successful authentication.

19. The method of claim 18, wherein the first authentication attempt is an active authentication attempt, and wherein the second authentication attempt is a passive authentication attempt.

20. The method of claim 18, wherein the first authentication attempt is performed within a pre-determined time window prior to the second authentication attempt.

21. The method of claim 18, wherein the first authentication attempt is performed within a pre-determined number of previous authentication attempts prior to the acquisition of the second set of biometric data.
